(19) United States
(12) Patent Application Publication
(10) Pub. No.: US 2024/0149740 A1
(43) Pub. Date: May 9, 2024

(54) PUBLIC TRANSPORT VEHICLE CHARGING SYSTEM AND PUBLIC TRANSPORT VEHICLE CHARGING METHOD

(71) Applicant: INSTITUTE FOR INFORMATION INDUSTRY, TAIPEI (TW)

(72) Inventors: Yweting TSAI, Taipei (TW); Shih-I CHEN, Taipei (TW); Kuo-Hua WU, Taipei (TW); Yu-Jin LIN, Taipei (TW); Hong-Tzer YANG, Taipei (TW)

(21) Appl. No.: 18/057,232

(22) Filed: Nov. 21, 2022

(30) Foreign Application Priority Data
Nov. 7, 2022 (TW) 111142452

(51) Int. Cl. B60L 53/68; B60L 53/66; B60L 53/67; G01C 21/34; G06Q 50/06

(52) U.S. Cl. CPC B60L 53/68; B60L 53/66; B60L 53/67; G01C 21/343; G01C 21/3484; G06Q 50/06

(57) ABSTRACT

A public transport vehicle charging system is applied to multiple charging stations and an electric vehicle. The public transport vehicle charging system includes a server communicatively connected to the charging stations and the electric vehicle. The server is configured to establish a charging decision model according to multiple historical conditions and a transport schedule. The server is configured to calculate multiple ideal decisions according to the historical conditions and the transport schedule, so as to adjust multiple parameters in the charging decision model. When the electric vehicle drives toward a first charging station according to the transport schedule, the server is configured to input a current condition into the charging decision model, so as to selectively charge the electric vehicle by the first charging station. The current condition includes a current remaining power and a current position of the electric vehicle.

### CROSS-REFERENCE TO RELATED APPLICATION

This application claims priority to Taiwan Application Serial Number 111142452, filed Nov. 7, 2022, which is herein incorporated by reference in its entirety.

### BACKGROUND

### Technical Field

The present disclosure relates to a charging system, in particular to a public transport vehicle charging system and a public transport vehicle charging method.

### Description of Related Art

Recently, with the rapid development of electric vehicle technology and market, the application of electric vehicles has become extensive. Although electric vehicles have the advantages of low exhaust gas, zero pollution, low noise, and low vibration, electric vehicles are limited by the existing battery structure and energy storage technology, resulting in limited endurance. Therefore, charging system has become one of the important factors affecting the popularization of electric vehicles.

### SUMMARY

One aspect of the present disclosure is a public transport vehicle charging system applied to a plurality of charging stations and an electric vehicle. The electric vehicle is configured to drive between the plurality of charging stations according to a transport schedule. The public transport vehicle charging system comprises a server. The server is communicatively connected to the plurality of charging stations and the electric vehicle. The server is configured to establish a charging decision model according to a plurality of historical conditions and the transport schedule, and is configured to calculate a plurality of ideal decisions according to the plurality of historical conditions and the transport schedule, so as to adjust a plurality of parameters in the charging decision model. When the electric vehicle drives toward a first charging station of the plurality of charging stations according to the transport schedule, the server is configured to input a current condition into the charging decision model, so as to selectively charge the electric vehicle by the first charging station. The current condition comprises a current remaining power and a current position of the electric vehicle.

Another aspect of the present disclosure is a a public transport vehicle charging system applied to a plurality of charging stations and an electric vehicle. The electric vehicle is configured to drive between the plurality of charging stations according to a transport schedule. The public transport vehicle charging system comprises a server. The server is communicatively connected to the plurality of charging stations and the electric vehicle. The server is configured to establish a charging decision model according to a plurality of historical conditions and the transport schedule, and is configured to calculate a plurality of ideal decisions according to the plurality of historical conditions and the transport schedule, so as to adjust a plurality of parameters in the charging decision model. When the electric vehicle drives toward a first charging station of the plurality of charging stations according to the transport schedule, the server is configured to input a current condition into the charging decision model, so as to selectively charge the electric vehicle by the first charging station. The current condition comprises a current remaining power of the electric vehicle and a current power supply data of one of the plurality of charging stations.

Another aspect of the present disclosure is a public transport vehicle charging method comprising: inputting a historical condition and a transport schedule into a charging decision model to obtain a training decision, wherein the historical condition comprises comprises a historical remaining power and a historical position of the electric vehicle at a historical time point; comparing the training decision with a ideal decision to adjust the charging decision model; when the electric vehicle drives toward a first charging station of a plurality of charging stations according to the transport schedule, inputting a current condition into the charging decision model to obtain a current decision, wherein the current condition comprises a current remaining power and a current position of the electric vehicle; and selectively charging the electric vehicle by the first charging station according to the current decision.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a public transport vehicle charging system in some embodiments of the present disclosure.

FIGS. 2A-2B are flowcharts illustrating a public transport vehicle charging method in some embodiments of the present disclosure.

FIG. 3A is a schematic diagram of the training process of charging decision model in some embodiments of the present disclosure.

FIG. 3B is a schematic diagram of the application process of charging decision model in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes an associated listed items or any and all combinations of more.

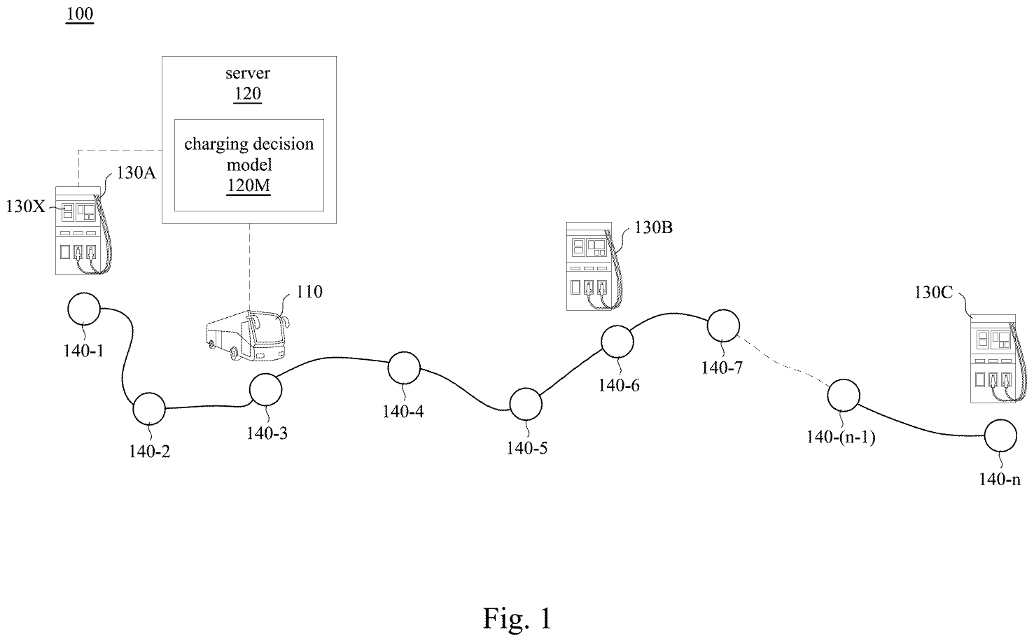

FIG. 1 is a schematic diagram of a public transport vehicle charging system 100 in some embodiments of the present disclosure. The public transport vehicle charging system 100 includes at least one electric vehicle 110 (e.g., electric bus), a server 120 and multiple charging stations 130A-130C. The electric vehicle 110 is provided with a battery to drive the power system (e.g., wheels) of the electric vehicle 110 according to the electric power of the battery.

The electric vehicle 110 drives between the charging stations 130A-130C according to a transport schedule. In some embodiments, the electric vehicle 110 stores the transport schedule, in some other embodiments, the electric vehicle 110 can connect to a server 120 through communication network to obtain the transport schedule. The transport schedule includes locations, distances and departure times of all charging stations 130A-130C. In some embodiments, the transport schedule further includes driving data corresponding to the electric vehicle 110. For example, when the electric vehicle 110 is driving between the charging stations 130A-130C, the expected driving speed of the electric vehicle 110, and/or the electricity consumption of the electric vehicle 110 at different driving speeds.

As shown in figure, in one embodiment, the public transport vehicle charging system 100 further includes multiple vehicle stations 140-1-140-n. The charging stations 130A-130C can be respectively set in one of the vehicle stations 140-1-140-n. In other words, the locations of the charging stations 130A-130C can be the same as the locations of the corresponding vehicle stations 140-1-140-n.

The charging stations 130A-130C may connect to a power grid, or is provided with an energy storage system 130X, and is configured to provide power to the electric vehicle 110. When the electric vehicle 110 stops at the charging stations 130A-130C (or the vehicle stations 140-1-140-n), the electric vehicle 110 can be charged by the charging stations 130. The charging method can be to directly connect the electric vehicle 110 to the charging stations 130A-130C, or remove the battery of the electric vehicle 110 to charge the battery by the energy storage system 130X. In some other embodiments, the charging method can also be “replace the old battery with a new one”.

For example, the charging stations 130A-130C (or the energy storage system 130X) can be implemented to a battery exchange station, including a charging base and multiple battery slots. The battery slots are used to store multiple portable batteries and charge the portable batteries.

The server 120 is communicatively connected (e.g., by internet) to the electric vehicle 110 and the charging stations 130A-130C, so as to receive status data (e.g., remaining power, current load, current position) of the electric vehicle 110 and the charging stations 130A-130C in real time or periodically. The server 120 stores a charging decision model 120M. The server 120 can determine whether to charge the electric vehicle 110 by the charging decision model 120M.

When establishing the charging decision model 120M, the server 120 uses a large number of historical conditions, and cooperates with the transport schedule to train multiple parameters in the charging decision model 120M, so as to adjust the parameters of the charging decision model 120M for different conditions through machine learning or neural network. The aforementioned “historical conditions” include traffic status (e.g., whether the road is congested), vehicle status (e.g., driving speed, remaining power of the battery, the current position), charging stations status (e.g., remaining power of the energy storage system) and time period data (e.g., Time of Use Rates, TOU), the details will be detailed in the following paragraphs.

After establishing the charging decision model 120M, the server 120 also uses an algorithm to perform actual calculations on the same historical conditions and the transport schedule to calculate at least a corresponding ideal decision (i.e., to determine the charging timing of the electric vehicle 110).

As mentioned above, “algorithm” is a calculation formula formed according to operating parameters of the electric vehicle 110 (e.g., the electricity consumption between each of the charging stations), operating parameters of the charging stations 130A-130C (e.g., current load of the charging stations, remaining power of the energy storage system 130X), and/or time parameters (e.g., electricity prices at different times). When a certain historical time point (e.g., the electric vehicle 110 is about to stop at a first charging station 130A), the server 120 determines whether it is an appropriate charging time, determines whether charging at this time will cause a delay in departure time, or determines whether the remaining power of the electric vehicle 110 is sufficient to maintain until the next charging stations before charging.

As shown in FIG. 1, for example, ten electric vehicles are about to stop at the charging stations 130A-130C at a certain point in time, wherein the remaining power of two electric vehicles is below a threshold (e.g., at the ideal driving speed, the remaining power is not sufficient to maintain to the next charging stations 130A-130C or the next vehicle stations 140-1-140-n). At this time, since the algorithm uses operating parameters of the electric vehicle 110, operating parameters and/or time parameters of the charging stations 130A-130C as variables of the calculation formula, the server 120 inputs the operating parameters of the two electric vehicle 110 and operating parameters and/or time parameters of the corresponding charging stations 130A-130C into the algorithm, the current charging urgency level (e.g., a value of 0-1), or the current charging cost can be determined. Accordingly, the server 120 can selectively control or notify the two electric vehicles to charge at the corresponding charging stations according to the result of the algorithm.

The server 120 compares each “training decision” of the charging decision model 120M during training with the “ideal decision” calculated by the algorithm to adjust the parameters in the charging decision model 120M, selectively. If the decision results of the two (i.e., the training decision and the ideal decision) are the same, the server 120 increases a verification parameter corresponding to the training decision in the charging decision model 120M (e.g., +1). On the other hand, if the decision results of the two are different, the server 120 decrease the verification parameter corresponding to the training decision in the charging decision model 120M (e.g., −1).

The aforementioned “enhanced learning” mechanism uses data of the public transport vehicle charging system 100 as historical condition(s) to train the charging decision model 120M. Therefore, various variables such as the entire system, fleet, and traffic status can be taken into consideration, so that the decision made by the charging decision model 120M can aim at “optimization of system operation”. In addition, the charging decision model 120M is constructed by machine learning and neural network technology. Therefore, when actually making a decision, it only need to input current condition into the charging decision model 120M, and the decision result can be quickly obtained (i.e., whether it is currently charging).

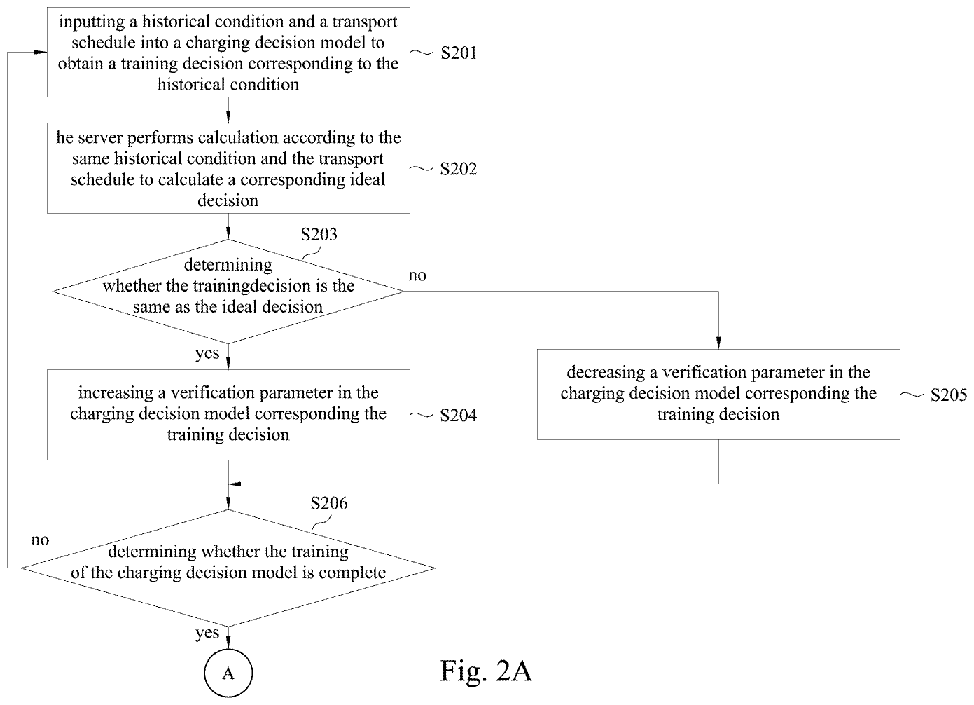

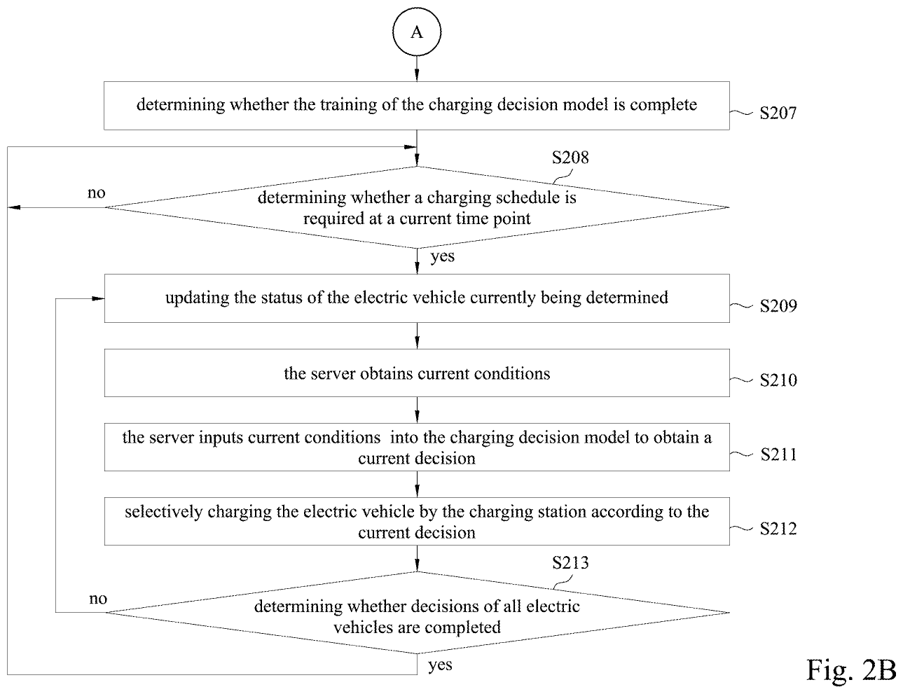

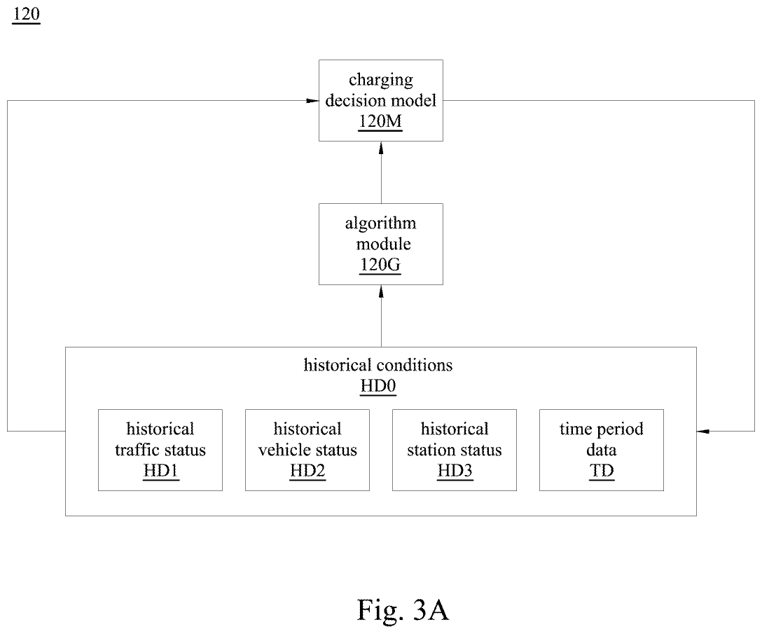

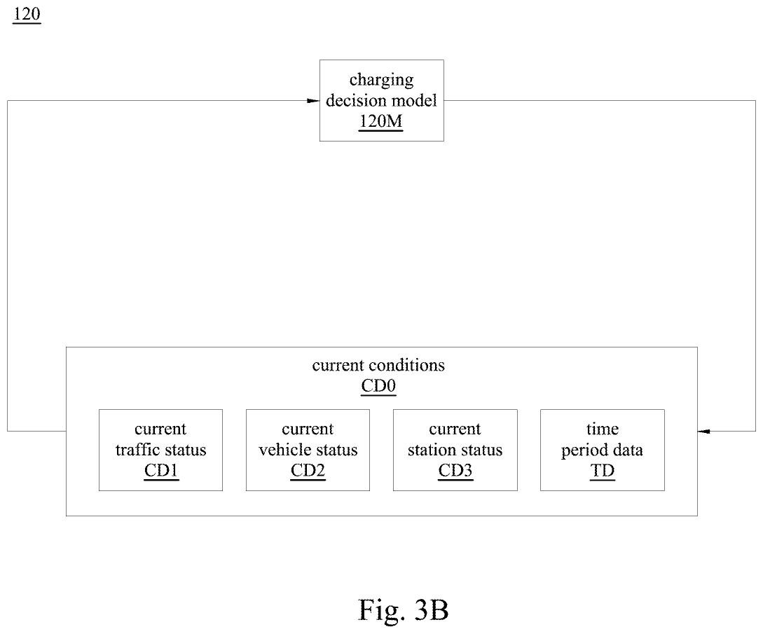

FIGS. 2A-2B are flowcharts illustrating a public transport vehicle charging method in some embodiments of the present disclosure. FIG. 2A illustrates the training process of charging decision model 120M in some embodiments of the present disclosure, and the corresponding system schematic diagram is FIG. 3A. FIG. 2B illustrates the application process of charging decision model 120M in some embodiments of the present disclosure, and the corresponding system schematic diagram is FIG. 3B.

In step S201, the server 120 inputs at least one historical condition HD0 (this embodiment is multiple historical conditions, and the server 120 may input one of historical conditions HD0) and a transport schedule into a charging decision model 120M, to obtain a training decision corresponding to the historical condition HD0. when generating the training decision by the charging decision model 120M, the corresponding parameter value of each variable (e.g., the historical condition) will be affected accordingly.

The aforementioned “the historical condition HD0” corresponds to a specific time point (e.g., when the electric vehicle 110 drives to a specific position, or a set specific time, referred to here as “historical time point”), and can be a combination of one or more of the following data types: historical traffic status HD1, historical vehicle status HD2, historical station status HD3, and time period data TD.
(1) Historical traffic status HD1: the historical traffic status HD1 includes road conditions of road the electric vehicle 110 is driving, which can be obtained by analyzing the road data on the network, for example, whether the road is congested, and the expected driving speed.
(2) Historical vehicle status HD2: the historical vehicle status HD2 includes remaining power of the battery in the electric vehicle 110 (herein referred to as the historical remaining power), position of the electric vehicle 110 (herein referred to as the historical position), speed of the electric vehicle (herein referred to as historical speed).
(3) Historical station status HD3: the historical station status HD3 includes the solar power generated by the energy storage system 130X, the charging capacity provided by the charging stations 130A-130C (e.g., the charging power of the power grid, the remaining power of the energy storage system 130X, etc., referred to here as the historical power supply data), the internal load status of the charging stations 130A-130C (e.g., power consumption of lights, display screens, air conditioners and other equipment in the vehicle stations 140-1-140-n) and transformer status of the charging stations, etc.
(4) Time period data TD: the time period data TD is configured to record the power supply condition of the power grid at the historical time point, such as different electricity prices corresponding to different time of day (e.g., day or night). In addition, the time period data can also record relevant information of power consumption strategy according to “demand response” or “contract capacity”.

In step S202, the server 120 uses the internal algorithm module 120G to perform actual calculations on the same historical condition and the transport schedule to calculate the corresponding ideal decision. The algorithm module 120G may be implemented to a processing circuit, or an algorithm installed/stored in a memory. As mentioned above, the algorithm module 120G evaluates according to “necessity of charging the electric vehicle 110” and “the time period data (e.g., the cost of charging at the moment)”.

In step S203, the server 120 compares the ideal decision and the training decision of the same historical condition HD0. In other words, the server 120 determines whether the training decision made by the charging decision model 120M is consistent with the ideal decision actually calculated by the algorithm module 120G.

According to the comparison result, the server 120 will selectively adjust the verification parameter corresponding to the training decision in the charging decision model 120M. If the ideal decision is consistent with the training decision, in step S204, the server 120 increases the verification parameter corresponding to the training decision in the charging decision model 120M. On the other hand, if the ideal decision is not consistent with the training decision, in step S205, the server 120 decreases the verification parameter corresponding to the training decision in the charging decision model 120M.

As shown in FIG. 3A, for example, when the electric vehicle 110 is driving toward the first charging station 130A according to the transport schedule (i.e., the electric vehicle 110 is about to stop at the first charging station 130A), the server 120 inputs the historical condition (i.e., the historical traffic status, the historical vehicle status, the historical station status and/or the time period data) into the charging decision model 120M. At this time, the charging decision model 120M may evaluate a decision that “the electric vehicle 110 does not need to be charged at the first charging station 130A” (i.e., the training decision). Then, the server 120 actually calculates the “necessity of current charging” and “the cost of charging the electric vehicle 110 at different charging stations 130A-130C” according to the algorithm, so as to determine whether the electric vehicle 110 needs to be charged at the first charging station 130A.

If the calculation result of the server 120 is “the electric vehicle 110 does not need to be charged at the first charging station 130A” (i.e., the ideal decision), it means that the ideal decision is consistent with the training decision. At this time, the server 120 increases the verification parameter related to the training decision. For example, increases a weighted value of each parameter related to the training decision.

On the other hand, if the calculation result of the server 120 is “the electric vehicle 110 must be charged at the first charging station 130A” (i.e., the ideal decision), it means that the ideal decision is not consistent with the training decision. At this time, the server 120 decreases the weighted value of each parameter related to the training decision.

In step S206, the server 120 determine whether the training of the charging decision model 120M is complete. In some embodiments, the server 120 can set the training times of the charging decision model 120M. For example, the charging decision model 120M must use at least N sets of historical conditions to train. If the server 120 determines that the charging decision model 120M has not completed training, return to step S201. If the server 120 determines that the charging decision model 120M has been trained complete, the charging decision model 120M can be actually applied to the public transport vehicle charging system 100, so as to instantly evaluate the charging timing of the electric vehicle 110, as shown in FIG. 2B.

As shown in FIGS. 2B and 3B, in step S207, the server 120 initializes parameters, and obtains various status data of the electric vehicle 110 and/or the charging stations 130. In step S208, the server 120 determines whether a “charging schedule” needs to be performed at the current time point, and determines the number of the electric vehicles 110 that need to perform the “charging schedule”. In some embodiments, the server 120 determines whether a distance between the current position of each electric vehicle 110 and the closest charging stations (e.g., the first charging station 130A) is less than a determination threshold. If the electric vehicle 110 is driving towards the charging stations, and the distance is less than the determination threshold, it means that the electric vehicle 110 is about to approach the charging stations, and the charging schedule needs to be performed. In some other embodiments, the server 120 may evaluate the same electric vehicle 110 again at a predetermined interval (e.g., 5 minutes).

In step S209, the server 120 updates the status of the electric vehicle 110 currently being determined, to obtain or update the current vehicle status CD2. The current vehicle status CD2 may be the remaining power, position and/or speed of the electric vehicle 110.

In step S210, the server 120 obtains at least one current condition CD0. In step S211, the server 120 inputs the current condition CD0 into the charging decision model 120M to obtain a current decision (i.e., whether to charge the electric vehicle 110 by the first charging station 130A).

The current condition CD0 can be a combination of one or more of the following data types: the current traffic status CD1, the current vehicle status CD2, the current charging stations status CD3, the time period data TD.
(1) Current traffic status CD1: the current traffic status CD1 includes road conditions of road the electric vehicle 110 is driving, which can be obtained by analyzing the road data on the network, for example, whether the road is congested, and the expected driving speed.
(2) Current vehicle status CD2: the current vehicle status CD2 includes remaining power of the battery in the electric vehicle 110 (herein referred to as the current remaining power), position of the electric vehicle 110 (herein referred to as the current position), current speed of the electric vehicle 110.
(3) Current charging stations status CD3: the current charging stations status CD3 includes the current solar power generated by the energy storage system 130X, the current charging capacity provided by the charging stations 130A-130C (e.g., the charging power of the power grid, the remaining power of the energy storage system 130X, etc., referred to here as the current power supply data), the current internal load status of the charging stations 130A-130C (e.g., power consumption of lights, display screens, air conditioners and other equipment in the vehicle stations 140-1-140-n) and current transformer status of the charging stations, etc.
(4) Time period data TD: the time period data TD is configured to record the power supply condition of the power grid at the historical time point, such as different electricity prices corresponding to different time of day (e.g., day or night). In addition, the time period data can also record relevant information of power consumption strategy according to “demand response” or “contract capacity”.

As stated above, the current condition CD0 includes similar data types as the historical condition HD0. However, in some embodiments, the amount of data of the current condition CD0 may be less than the amount of data of the historical condition HD0, so that decisions can be made quickly during the driving of the electric vehicle 110. In addition, since the charging decision model 120M has completed a large amount of training in the training process shown in FIG. 2A, in the actual application shown in FIG. 2B, even if the amount of data in the current condition CD0 is less than that in the historical condition HD0, the charging decision model 120M can still complete the determination accurately and quickly.

Specifically, in one embodiment, the server 120 uses “the historical remaining power of the electric vehicle 110, the historical position of the electric vehicle 110, the historical traffic status” as the historical condition HD0 to train the charging decision model 120M. When the charging decision model 120M is actually applied to determine the charging timing of the electric vehicle 110 in real time, the server 120 can only use “the current remaining power of the electric vehicle 110 and the current position of the electric vehicle 110” as the current condition CD0, and inputs the current condition CD0 into the charging decision model 120M to obtain the current decision.

As mentioned above, in view of the fact that it has limited evaluate time during the electric vehicle 110 driving, and the charging decision model 120M has previously been trained through a large amount of the historical conditions HD0, therefore, after generating the current decision, the server 120 does not need to use the algorithm module 120G to verify the current decision again.

In step S212, the server 120 selectively charges the electric vehicle 110 by the charging stations 130A-130C according to the current decision. In other words, the server 120 determines whether to charge the electric vehicle 110 immediately by the first charging station 130A, or charge the electric vehicle 110 by other charging stations 130B-130C.

After determining the charging timing of one of electric vehicles through steps S209-S212, in step S213, the server 120 determines whether all charging decisions of the electric vehicle 110 have been completed. If the charging decisions of all the electric vehicle 110 have not been completed, then return to step S209 to evaluate the current vehicle status CD2 of the next electric vehicle. If the charging decisions of all the electric vehicle 110 have been completed, then return to step S208 and stand by.

By training the charging decision model 120M through the process shown in FIG. 2A, and by performing real-time determination and making decision through the process shown in FIG. 2B, the server 120 can quickly determine/evaluate the appropriate timing to charge the electric vehicle 110 during the driving of the electric vehicle 110, and effectively manage the operating costs of the entire system or fleet.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A public transport vehicle charging system applied to a plurality of charging stations and an electric vehicle, wherein the electric vehicle is configured to drive between the plurality of charging stations according to a transport schedule, and the public transport vehicle charging system comprises:
a server communicatively connected to the plurality of charging stations and the electric vehicle, wherein the server is configured to establish a charging decision model according to a plurality of historical conditions and the transport schedule, and is configured to calculate a plurality of ideal decisions according to the plurality of historical conditions and the transport schedule, so as to adjust a plurality of parameters in the charging decision model;
wherein when the electric vehicle drives toward a first charging station of the plurality of charging stations according to the transport schedule, the server is configured to input a current condition into the charging decision model, so as to selectively charge the electric vehicle by the first charging station; and
wherein the current condition comprises a current remaining power and a current position of the electric vehicle.

2. The public transport vehicle charging system of claim 1, wherein one of the plurality of historical conditions comprises comprises a historical remaining power and a historical position of the electric vehicle at a historical time point.

3. The public transport vehicle charging system of claim 2, wherein the one of the plurality of historical conditions further comprises a historical traffic status and a plurality of historical power supply data of the plurality of charging stations, and the plurality of historical power supply data is configured to record a plurality of power supply status of the plurality of charging stations.

4. The public transport vehicle charging system of claim 2, wherein the one of the plurality of historical conditions further comprises a time period data, the time period data is configured to record a power supply condition of a power grid at the historical time point.

5. The public transport vehicle charging system of claim 1, wherein the transport schedule comprises a plurality of locations of the plurality of charging stations, and comprises an electricity consumption of the electric vehicle driving between the plurality of charging stations.

6. The public transport vehicle charging system of claim 1, wherein the server is configured to input one of the plurality of historical conditions and the transport schedule into the charging decision model to obtain a training decision, and the server is further configured to compare the training decision with one of the plurality of ideal decisions to adjust the plurality of parameters in the charging decision model according to a comparison result.

7. The public transport vehicle charging system of claim 6, wherein the server is configured to selectively adjust a verification parameter in the charging decision model corresponding the training decision according to the comparison result.

8. A public transport vehicle charging system applied to a plurality of charging stations and an electric vehicle, wherein the electric vehicle is configured to drive between the plurality of charging stations according to a transport schedule, and the public transport vehicle charging system comprises:
a server communicatively connected to the plurality of charging stations and the electric vehicle, wherein the server is configured to establish a charging decision model according to a plurality of historical conditions and the transport schedule, and is configured to calculate a plurality of ideal decisions according to the plurality of historical conditions and the transport schedule, so as to adjust a plurality of parameters in the charging decision model;
wherein when the electric vehicle drives toward a first charging station of the plurality of charging stations according to the transport schedule, the server is configured to input a current condition into the charging decision model, so as to selectively charge the electric vehicle by the first charging station; and
wherein the current condition comprises a current remaining power of the electric vehicle and a current power supply data of one of the plurality of charging stations.

9. The public transport vehicle charging system of claim 8, wherein one of the plurality of historical conditions comprises comprises a historical remaining power and a historical position of the electric vehicle at a historical time point, and the current condition further comprises a current position of the electric vehicle.

10. The public transport vehicle charging system of claim 9, wherein the one of the plurality of historical conditions further comprises a historical traffic status and a plurality of historical power supply data of the plurality of charging stations.

11. The public transport vehicle charging system of claim 9, wherein the one of the plurality of historical conditions further comprises a time period data, the time period data is configured to record a power supply condition of a power grid at the historical time point.

12. The public transport vehicle charging system of claim 8, wherein the transport schedule comprises a plurality of locations of the plurality of charging stations, and comprises an electricity consumption of the electric vehicle driving between the plurality of charging stations.

13. The public transport vehicle charging system of claim 8, wherein the server is configured to input one of the plurality of historical conditions and the transport schedule into the charging decision model to obtain a training decision, and the server is further configured to compare the training decision with one of the plurality of ideal decisions to adjust the plurality of parameters in the charging decision model according to a comparison result.

14. The public transport vehicle charging system of claim 13, wherein the server is configured to selectively adjust a verification parameter in the charging decision model corresponding the training decision according to the comparison result.

15. A public transport vehicle charging method comprising:
inputting a historical condition and a transport schedule into a charging decision model to obtain a training decision, wherein the historical condition comprises comprises a historical remaining power and a historical position of an electric vehicle at a historical time point;
comparing the training decision with a ideal decision to adjust the charging decision model;
when the electric vehicle drives toward a first charging station of a plurality of charging stations according to the transport schedule, inputting a current condition into the charging decision model to obtain a current decision, wherein the current condition comprises a current remaining power and a current position of the electric vehicle; and
selectively charging the electric vehicle by the first charging station according to the current decision.

16. The public transport vehicle charging method of claim 15, wherein comparing the training decision with the ideal decision to adjust the charging decision model comprises:
calculating, by a server, according to the historical condition and the transport schedule to obtain the ideal decision; and
selectively adjusting a verification parameter in the charging decision model corresponding the training decision according to a comparison result of the training decision and the ideal decision.

17. The public transport vehicle charging method of claim 15, wherein the historical condition comprises comprises a historical traffic status and a plurality of historical power supply data of the plurality of charging stations.

18. The public transport vehicle charging method of claim 15, wherein the historical condition comprises a time period data, the time period data is configured to record a power supply condition of a power grid at the historical time point.

19. The public transport vehicle charging method of claim 15, wherein the transport schedule comprises a plurality of locations of the plurality of charging stations, and comprises an electricity consumption of the electric vehicle driving between the plurality of charging stations.

20. The public transport vehicle charging method of claim 15, inputting the current condition into the charging decision model to obtain the current decision comprises:
determining whether a distance between the current position of the electric vehicle and the first charging station is less than a determination threshold.
